(19) United States
(12) Patent Application Publication
(10) Pub. No.: US 2018/0354305 A1
(43) Pub. Date: Dec. 13, 2018

(54) TIRE PLY STEEL FABRIC HAVING SPECIFIED WEFT CORDS, RUBBER COVERED TIRE PLY THEREOF, AND RELATED PROCESSES

(71) Applicant: Bridgestone Americas Tire Operations, LLC, Nashville, TN (US)

(72) Inventors: Albert H. Robinson, Franklin, TN (US); Chad J. Kresge, Canton, OH (US); James F. Donahue, Akron, OH (US)

(73) Assignee: Bridgestone Americas Tire Operations, LLC, Nashville, TN (US)

(21) Appl. No.: 16/060,068

(22) PCT Filed: Dec. 15, 2016
(86) PCT No.: PCT/US16/66923

§ 371 Date: Jun. 7, 2018

Related U.S. Application Data
(60) Provisional application No. 62/268,544, filed on Dec. 17, 2015.

(51) Int. Cl. B60C 9/00; D03D 1/00; D03D 15/02

(52) U.S. Cl. CPC B60C 9/005; B60C 9/0007; B60C 9/0042; D03D 1/00; D03D 2700/0196; D03D 2700/0137; D10B 2505/022; D10B 2101/20; D10B 2201/02; D03D 15/02

(57) ABSTRACT

Disclosed herein are a tire ply steel fabric having specified weft cords, a rubber covered tire ply comprising the tire ply steel fabric, tires comprising the rubber covered tire ply, and related processes for producing a tire ply steel fabric with specific weft cords and for producing a rubber covered tire ply comprising the tire ply steel fabric. The tire ply steel fabric comprises a plurality of steel warp cords and a plurality of weft cords each weft cord having a core-sheath construction wherein the core comprises at least one filament of a non-metallic material having a specified Eb and the sheath comprises a different non-metallic material having a specified Eb that is lower than the Eb of the core material.

### FIELD

The present application is directed to a tire ply steel fabric having specified weft cords, a rubber covered tire ply comprising the tire ply steel fabric, tires comprising the rubber covered tire ply, and related processes for producing a tire ply steel fabric with specific weft cords and for producing a rubber covered tire ply comprising the tire ply steel fabric.

### BACKGROUND

Various types of tires incorporate in their radially inner interior one or more layers of “fabric” into their construction. The fabric is generally woven of warp cords and weft cords, with the warp cords generally being a textile material (such as cotton or nylon) or a metallic material (such as steel) and the weft cords generally being a textile material. The warp cords comprise the bulk of the fabric and are generally more closely spaced than the weft cords. The weft cords primarily function to hold together and maintain uniformity of the warp cords during certain stages of the tire manufacturing process. In certain applications the fabric is covered in rubber prior to being incorporated into the tire. Depending upon the type of tire, one or more fabric layers may be included in components such as a belt, a body ply, a cap ply, or a carcass ply. Fabrics utilized in body ply constructions for passenger and light truck tires have generally been constructed of textile warp and weft cords.

### SUMMARY

Disclosed herein are a tire ply steel fabric having specified weft cords, a rubber covered tire ply comprising the tire ply steel fabric, tires comprising the rubber covered tire ply, and related processes for producing a tire ply steel fabric with specific weft cords and for producing a rubber covered tire ply comprising the tire ply steel fabric.

In a first embodiment, a tire ply steel fabric is disclosed. The tire ply steel fabric comprises a plurality of steel warp cords having a diameter of at least 0.3 mm; a plurality of weft cords each weft cord having a core-sheath construction wherein the core comprises at least one filament of a non-metallic material having an Eb of at least 100% and the sheath comprises a different non-metallic material having an Eb of less than 100%; and a top and a bottom surface.

In a second embodiment, a rubber covered tire ply comprising a tire ply steel fabric is disclosed. The rubber covered tire ply comprises the tire ply steel fabric of the first embodiment with rubber covering on both the top and bottom surfaces of the fabric.

In a third embodiment, a tire comprising a rubber covered tire ply comprising a tire ply steel fabric is disclosed. The tire comprises the rubber covered tire ply of the second embodiment.

In a fourth embodiment, a process for producing a tire ply steel fabric is disclosed. The process comprises providing a plurality of steel cords having a diameter of at least 0.3 mm and a plurality of a non-metallic cords having a core-sheath construction wherein the core comprises at least one filament of a non-metallic material having an Eb of at least 100% and the sheath comprises a different non-metallic material having an Eb of less than 100%; weaving a fabric using the steel cords as warp cords and the non-metallic cords as weft cords, thereby producing a tire ply steel fabric having a top and a bottom surface.

### DETAILED DESCRIPTION

Disclosed herein are a tire ply steel fabric having specified weft cords, a rubber covered tire ply comprising the tire ply steel fabric, tires comprising the rubber covered tire ply, and related processes for producing a tire ply steel fabric with specific weft cords and for producing a rubber covered tire ply comprising the tire ply steel fabric.

In a first embodiment, a tire ply steel fabric is disclosed. The tire ply steel fabric comprises a plurality of steel warp cords having a diameter of at least 0.3 mm; a plurality of weft cords each weft cord having a core-sheath construction wherein the core comprises at least one filament of a non-metallic material having an Eb of at least 100% and the sheath comprises a different non-metallic material having an Eb of less than 100%; and a top and a bottom surface.

In a second embodiment, a rubber covered tire ply comprising a tire ply steel fabric is disclosed. The rubber covered tire ply comprises the tire ply steel fabric of the first embodiment with rubber covering on both the top and bottom surfaces of the fabric.

In a third embodiment, a tire comprising a rubber covered tire ply comprising a tire ply steel fabric is disclosed. The tire comprises the rubber covered tire ply of the second embodiment.

In a fourth embodiment, a process for producing a tire ply steel fabric is disclosed. The process comprises providing a plurality of steel cords having a diameter of at least 0.3 mm and a plurality of a non-metallic cords having a core-sheath construction wherein the core comprises at least one filament of a non-metallic material having an Eb of at least 100% and the sheath comprises a different non-metallic material having an Eb of less than 100%; weaving a fabric using the steel cords as warp cords and the non-metallic cords as weft cords, thereby producing a tire ply steel fabric having a top and a bottom surface. In certain embodiments of the fourth embodiment, the process further comprises covering both the top and the bottom surfaces of the fabric with rubber, thereby producing a rubber covered tire ply.

### Definitions

The terminology as set forth herein is for description of the embodiments only and should not be construed as limiting the invention as a whole.

As used herein, the term “cord” means a strand made of a metallic or non-metallic material. An individual cord may be comprised of multiple filaments.

As used herein, the terms “covered” and “covering” as used in the phrases “rubber covered tire ply” and “rubber covering on both sides of the fabric” is intended to encompass a tire ply fabric whose outer surface (i.e., top and bottom) is almost entirely or entirely enveloped in rubber (i.e., a rubber composition). The fabric may be covered with a rubber composition as a result of various processes such as calendering a rubber sheet or sheets over the cords (or fabric containing the cords) or extruding the cords (or fabric containing the cords) with the rubber composition, although the particular process utilized is not significant as long as a rubber coating over the cords/fabric results. The rubber sheet used for covering the textile cords may also be referred to as a ply skim. By almost entirely or entirely enveloped is meant that both outer surfaces of the fabric (i.e., top and bottom) are at least 95% covered with the rubber composition, preferably a continuous length of at least 16 cm of the rubber covered fabric (or a section of fabric of at least 40 cm²) meets the foregoing.

As used herein, the term “majority” means more than 50%. Accordingly, the phrase “at least a majority” should be understood as meaning more than 50%.

As used herein, the term “steel” as used in the phrase “steel cords” should be understood to include steel alloys.

### Steel Warp Cords, Weft Cords

As discussed above, the tire ply steel fabric of the first embodiment comprises a plurality of steel warp cords. Similarly, the rubber covered tire ply of the first embodiment, the tire of the third embodiment, and the related processes of the fourth embodiment include a plurality of steel warp cords as part of the tire ply steel fabric. For ease of discussion, the steel warp cords of the first-fourth embodiments are discussed together herein and the following discussion should be considered to apply equally to each embodiment unless specified to the contrary.

The steel warp cords have a diameter in at least one direction of at least 0.3 mm, including 0.3 to about 5 mm (e.g., 0.32, 0.4, 0.5, 0.6, 0.7, 0.8, 0.9, 1, 2, 3, 4, 5 mm), 0.3 to 5 mm, 0.3 to about 4 mm, 0.3 to 4 mm, 0.3 to about 3 mm, 0.3 to 3 mm, 0.3 to about 2 mm, 0.3 to 2 mm, 0.3 to about 1 mm, 0.3 to 1 mm, 0.32 to 5 mm, 0.32 to about 4 mm, 0.32 to 4 mm, 0.32 to about 3 mm, 0.32 to 3 mm, 0.32 to about 2 mm, 0.32 to 2 mm, 0.32 to about 1 mm, 0.32 to 1 mm, 0.4 to about 5 mm, 0.4 to 5 mm, 0.4 to about 4 mm, 0.4 to 4 mm, 0.4 to about 3 mm, 0.4 to 3 mm, 0.4 to about 2 mm, 0.4 to 2 mm, 0.4 to about 1 mm, 0.4 to 1 mm, 0.5 to about 5 mm, 0.5 to 5 mm, 0.5 to about 4 mm, 0.5 to 4 mm, 0.5 to about 3 mm, 0.5 to 3 mm, 0.5 to about 2 mm, 0.5 to 2 mm, 0.5 to about 1 mm, and 0.5 to 1 mm. In certain embodiments, the steel warp cords have a diameter in at least one direction of about 0.4 to about 2 mm or 0.4 to 2 mm.

The steel warp cords may be of a unitary construction (i.e., each cord comprises only one filament) or alternatively may be comprised of more than one individual filament. In those embodiments where the steel warp cords are comprised of more than one individual filament, various constructions can be utilized such as a 1×N construction wherein a core filament is surrounded by N sheath filaments with are wrapped around the core. In certain embodiments N is an integer from 2-20 (e.g., 1×2, 1×3, 1×4, 1×5, etc.), preferably from 3 to 15, 3 to 10, or 3 to 7. In certain embodiments more than one filament is utilized in the core (e.g., 2 filaments, 3 filaments, 4 filaments or more) in combination with N sheath filaments, such as specified above. In certain embodiments, the steel warp cords have a m+n construction where m=1 to 5 and n=1 to 20 (preferably 2 to 15). Alternatively, in other embodiments different constructions such as twisting of more than one filament into a bundle and assembly of the bundles into a cord, optionally with one or more additional filaments wrapped around the outside of the assembled bundles, may be utilized. Depending upon the particular construction utilized, the size of the individual filaments used in a multifilament steel warp cord may vary. In certain embodiments, the diameter for the individual filaments of the steel warp cords may range from greater than 0.16 to about 0.5 mm, preferably 0.2 to 0.4 mm. Additionally, in those embodiments where more than one filament is used in the steel warp cord various levels of twisting can be utilized.

As discussed above, the tire ply steel fabric of the first embodiment comprises a plurality of weft cords. Similarly, the rubber covered tire ply of the first embodiment, the tire of the third embodiment, and the related processes of the fourth embodiment include a plurality of weft cords as part of the tire ply steel fabric. For ease of discussion, the weft cords of the first-fourth embodiments are discussed together herein and the following discussion should be considered to apply equally to each embodiment unless specified to the contrary. Weft cords are sometimes referred to as “pick” cords.

The weft cords of the first-fourth embodiments have a core-sheath construction wherein the core comprises at least one filament of a non-metallic material having an Eb of at least 100% and the sheath comprises a different non-metallic material having an Eb of less than 100%. The Eb refers to the elongation at break, i.e., the percentage elongation that can be reached before the final filament(s) break(s). Eb can be determined according to various procedures, including ASTM Method D885 and Method D2256 (single strand). The Eb values reported herein for the core filament(s) of the weft cord can be determined using a modified version of ASTM Method D2256 wherein a 25 mm segment of weft cord (with sheath intact to begin) is placed in an Instron machine and force is applied to elongate the cord; the elongation at break or Eb can be determined using the graph generated by the machine by marking the point at which resistance of the cord ceased due to complete breaking of the cord filaments. The % elongation can then be determined using that elongation length and comparing it to the starting length (i.e., 25 mm). As a non-limiting example, if the cord started at 25 mm in length and point marked on the graph was 75 mm then the Eb would be 200%. Preferably, in order to minimize measurement variability, the Eb value is measured five (5) times and the values averaged. According to the first-fourth embodiments disclosed herein, the filament(s) of the core (and/or the overall core) will have a higher Eb than the filament(s) of the sheath (and/or the overall sheath). In certain embodiments, the filament(s) of the core (and/or the overall core) have an Eb of at least 150%, at least 200%, at least 300%, at least 400%, at least 500%, at least 600%, at least 700% or more. In certain embodiments, the filament(s) of the core (and/or the overall core) have an Eb of 100-1500% (e.g., 100%, 150%, 200%, 300%, 400%, 500%, 600%, 700%, 800%, 900%, 1000%, 1100%, 1200%, 1300%, 1400%, 1500%), including 200-1500%, 200-1400%, 200-1300%, 200-1200%, 200-1100%, 300-1000%, 300-1500%, 300-1400%, 300-1300%, 300-1200%, 300-1100%, 300-1000%, 400-1500%, 400-1400%, 400-1300%, 400-1200%, 400-1100%, 400-1000%, 500-1500%, 500-1400%, 500-1300%, 500-1200%, 500-1100%, 500-1000%, 600-1500%, 600-1400%, 600-1300%, 600-1200%, 600-1100%, 600-1000%, 700-1500%, 700-1400%, 700-1300%, 700-1200%, 700-1100%, or 700-1000%. In certain embodiments, the sheath comprises one or more filaments. In other embodiments, the sheath comprises fibers that have been twisted or otherwise spun around the core of the weft cord; in certain such embodiments the sheath portion of the weft cord has a lower Eb than the core portion of the weft cord such that upon stretching up to the break point of the overall cord, the sheath portion will break or fracture into multiple portions prior to stretching the overall cord to 100% more than its original length. In certain embodiments, the weft cord comprises filament(s) of the sheath having an Eb of less than 90%, less than 80%, less than 70%, less than 60%, less than 50%, less than 40%, or less than 30%. In certain embodiments, the filament(s) of the sheath have an Eb of about 5 to about 90%, 5 to 90%, about 5 to about 80%, 5 to 80%, about 5 to about 70%, 5 to 70%, about 5 to about 60%, 5 to 60%, about 5 to about 50%, 5 to 50%, about 5 to about 40%, 5 to 40%, about 5 to about 30%, or 5 to 30%. The foregoing Eb values should be understood to apply equally to those embodiments of the first-fourth embodiments wherein the sheath comprises fibers that have been twisted or otherwise spun around the core of the weft cord. In certain embodiments, the weft cord has limited elastic deformation (e.g., its ability to return to its original length after stretching is limited) and instead experiences primarily plastic deformation. In certain embodiments, the limited elastic deformation of the weft cord is caused by limited elastic deformation of the core filament(s) in the weft cord which instead experience primarily plastic deformation. In certain embodiments, either the weft cord, the sheath filament(s) of the weft cord, or both experiences plastic deformation such that upon stretching to 100% of its original length upon the application of force, the section of cord or filament maintains at least 70% (e.g., 70%, 75%, 80%, 85%, 90%, 95%, or 100%) of its stretched length when the force is removed. In certain embodiments, either the weft cord, the core filament(s) of the weft cord, or both experiences plastic deformation such that upon stretching to 150, 200, 250, 300% or more (up to at least 10% below the Eb) of its original length upon the application of force, the section of cord or filament maintains at least 70% (e.g., 70%, 75%, 80%, 85%, 90%, 95%, or 100%) of its stretched length when the force is removed. Without being bound by theory, the ability of the weft cord, the core filament(s) of the weft cord, or both to deform in a primarily plastic manner can be advantageous when the tire ply steel fabric containing the weft cords is incorporated into a tire (such as in a body ply of the tire).

The size of certain filaments and cords such as those made from textiles is often expressed in units of mass per length. One such measurement is denier which refers to the mass in grams per 9000 meters of length and other such measurements are decitex (often abbreviated as dtex) which refers to the mass in grams per 10,000 meters of length and tex (decitex=10×tex) which refers to the mass in grams per 1,000 meter of length. The (overall) denier of the weft cord may vary and in certain embodiment is about 100 to about 1000 denier, including 100 to 1000 denier (e.g., 100, 150, 200, 250, 300, 350, 400, 450, 500, 600, 700, 800, 900, 1000 denier), about 100 to about 900 denier, 100 to 900 denier, about 100 to about 800 denier, 100 to 800 denier, about 100 to about 700 denier, 100 to 700 denier, about 100 to about 600 denier, 100 to 600 denier, about 100 to about 500 denier, 100 to 500 denier, about 150 to about 900 denier, 150 to 900 denier, about 150 to about 800 denier, 150 to 800 denier, about 150 to about 700 denier, 150 to 700 denier, about 150 to about 600 denier, 150 to 600 denier, about 150 to about 500 denier, 150 to 500 denier, about 200 to about 900 denier, 200 to 900 denier, about 200 to about 800 denier, 200 to 800 denier, about 200 to about 700 denier, 200 to 700 denier, about 200 to about 600 denier, 200 to 600 denier, about 200 to about 500 denier, and 200 to 500 denier. Similarly, the denier of the core and sheath of the weft cord may also vary.

The particular non-metallic material for the filament(s) of the core of the weft cord may vary as long as it provides the specified Eb, as discussed above. By non-metallic is meant that the filament(s) are not made of a metal or a metal alloy (e.g., they are not made of steel or a steel alloy). In certain embodiments, the filament(s) of the core of the weft cord comprise(s) at least one material selected from nylon, polyester, polypropylene, polyethylene, aramaid, or spandex. As used herein, “spandex” has its usual definition, that is, a manufactured fiber in which the fiber-forming substance is a long chain synthetic polymer composed of at least 85% by weight of a segmented polyurethane. As those of skill in the art will understand, the individual filament(s) may be made from fibers of polymeric substances such as, but not limited to, those in the foregoing list. In certain embodiments, the filament(s) of the core of the weft cord comprise(s) nylon; in certain such embodiments the nylon comprises unoriented or partially unoriented nylon. Unoriented or partially unoriented nylon may also be referred to as undrawn nylon.

The particular non-metallic material for the filament(s) of the sheath of the weft cord may vary as long as it provides the specified Eb, as discussed above. In certain embodiments, the filament(s) of the sheath of the weft cord comprise(s) at least one material selected from cotton, rayon, wool, sisal, cellulose, silk, linen, or flax. In certain embodiments, the filament(s) of the sheath of the weft cord comprises cotton. In certain embodiments, the sheath of the weft cord comprise carded, chopped filaments; in certain such embodiments, the carded chopped filaments comprise nylon/polyamide, polyester, polypropylene, wool, polyvinyl fibers, acrylic, polyethylene, polyurethane, or a combination thereof.

Generally, the sheath of the weft cord surrounds (at least partially) the core of the weft cord. In certain embodiments, the core of the weft cord has at least 75% of its outer surface surrounded by the filament(s) of the sheath (in an unstretched form). In other embodiments, the core of the weft cord has at least 80%, at least 85%, at least 90%, at least 95%, at least 98%, at least 99% or even 100% of its outer surface surrounded by the filament(s) of the sheath. It is intended that the foregoing percentages can be measured upon a sample of fabric that is 2.5 cm² focusing upon one weft cord or upon an average measurement across weft cords within the sample, or upon a sample of the weft cord that has not been incorporated into the fabric.

In certain embodiments, the weft cords, the warp cords, or both are treated with an adhesive composition preferably prior to being assembled into the tire ply fabric but optionally after assembly into the tire ply fabric. Such a treatment improves the adhesion between the material of the weft cords and the rubber covering. Suitable adhesive compositions are well known including those based upon combinations of resorcinol, formaldehyde, and rubber latex.

### Tire Ply Steel Fabric

As discussed above, the tire ply steel fabric is woven from warp cords and weft cords with the warp cords comprising a majority of the fabric (both in terms of number of cords and by weight). After covering with rubber, the tire ply steel fabric can be described as a rubber covered tire ply. The rubber covered tire ply can be incorporated into a tire. In certain embodiments, the rubber covered tire ply constitutes a body ply within the tire. For ease of discussion, the tire ply steel fabric of the first-fourth embodiments is discussed together herein and the following discussion should be considered to apply equally to each embodiment unless specified to the contrary. The “density” or number of warp cords utilized in the fabric may be expressed in terms of ends per inch. In certain embodiments, the tire ply steel fabric comprises at least 10 ends per inch (e.g., 10 ends per inch, 15 ends per inch, 20 ends per inch, 25 ends per inch, 30 ends per inch, 35 ends per inch, 40 ends per inch, 45 ends per inch, 50 ends per inch, etc.). In certain embodiments, the tire ply steel fabric comprises at least 10 ends per inch up to 50 ends per inch, 20 ends per inch up to 50 ends per inch, or 30 ends per inch up to 50 ends per inch. In certain embodiments, the tire ply steel fabric comprises 30-50 ends per inch, 30-48 ends per inch, 30-45 ends per inch, 30-43 ends per inch, 30-40 ends per inch, 30-38 ends per inch, 30-35 ends per inch, 35-50 ends per inch, 35-48 ends per inch, 35-45 ends per inch, 35-43 ends per inch, 35-40 ends per inch, 38-50 ends per inch, 38-48 ends per inch, 38-45 ends per inch, 38-43 ends per inch, or 38-40 ends per inch. The “density” or number of weft cords utilized in the fabric may be expressed in terms of the number of weft cords per linear inch of fabric. In certain embodiments, the tire ply steel fabric comprises 1 to 10 wefts per inch. In certain embodiments, the tire ply steel fabric comprises 1-8 wefts per inch, 1-5 wefts per inch, 1-3 wefts per inch, 3-10 wefts per inch, 3-8 wefts per inch, 3-5 wefts per inch, 5-10 wefts per inch, 5-8 wefts per inch, or 8-10 wefts per inch.

Another property that can be used to describe the tire ply steel fabric is the open area of the fabric which constitutes the surface area of the fabric (before covering with rubber) that is not made up of warp cords or weft cords. In other words, the open area of the fabric can be calculated by taking a given surface area of the fabric (e.g., a 2.5 cm² section) and subtracting the surface area made up of warp and weft cords. In certain embodiments, the tire ply steel fabric has an open area of at least 10% (based upon a 2.5 cm² fabric area section). In certain embodiments, the tire ply steel fabric has an open area of at least 20%, at least 30%, at least 40%, at least 50%, including up to about 70% (based upon a 2.5 cm² fabric area section). The open area of the tire ply steel fabric represents the area not accounted for by the cords, which is area available for rubber penetration when the fabric is covered with rubber on its top and bottom surfaces (rubber may also penetrate within the cords, e.g., between filaments). Open area of a fabric can be determined by various methods including a process as follows.

A six-inch by six-inch (15.2×15.2 cm) square sample of the material to be measured is placed flat on a light table having an intensity of 330 foot candles (3550 lux). If necessary, multiple 12 inch (30.5 cm) long pieces of ¼ inch (6.35 mm) steel bar stock can be used to hold down the edges of the sample to prevent bowing and wrinkling. An image of the sample back-lit by the light table is then captured using a digital camera (e.g., 6.5 mega-pixel digital SLR camera with a 24 mm lens) suspended above the table. To complete the measurement of open area the captured image is transferred to ADOBE PhotoShop® (or a similar program) for processing and analysis. Once in PhotoShop® the color image is converted to a grayscale image using the Image>Mode-Grayscale function. Then, the image is converted to a high contrast black and white image using the Image>Adjustments>Threshold function. For example, a threshold setting of 128 can be selected (0=black and 255=white). All pixels lighter than the threshold are converted to white; all pixels darker are converted to black. To further analyze the high contrast image it is necessary to select a representative area of the sample. To do this the rectangular marquee tool is used to highlight a representative section of the sample. The highlighted area is cropped Image>Crop. Finally, the mean intensity of the image is measured using the histogram tool. Since the image was converted to a high intensity black and white image, open areas in the sample have a pixel intensity of 255 and areas with fabric coverage have an intensity of 0. The measure of open area of the sample is obtained by dividing the mean pixel intensity by the intensity of a white pixel (255).

While the tire ply steel fabric can generally be laid flat and can be described as two-dimensional (with a top surface and a bottom surface), it does have a certain thickness which will be primarily dependent upon the thickness of the rubber covering, as discussed below. In certain embodiments, the tire ply steel fabric (without any rubber covering) will have a thickness of 0.5 to about 5 mm, 0.5 to 5 mm (e.g., 0.5 mm, 1 mm, 2 mm, 3 mm, 4, mm, 5 mm, preferably 0.5 to 3 mm, or 0.5 to 2 mm. As those of skill in the art will understand the thickness of the rubber covering can be varied depending upon the diameter of the cords used to prepare the fabric.

In certain embodiments, at least a majority (by number) of the warp cords within the tire ply steel fabric have at least a majority of their outer surface contacting a plurality of weft cords. In certain such embodiments, at least 60%, at least 70%, at least 80%, at least 90%, at least 95%, at least 98%, at least 99% or 100% (e.g., 60% to 100%, 60% to 99%, 60% to 98%, 60% to 95%, 60% to 90%, 60% to 80%, 60% to 70%, 70% to 100%, 70% to 99%, 70% to 98%, 70% to 95%, 70% to 90%, 70% to 80%, 80% to 100%, 80% to 99%, 80% to 95%, 80% to 90%, 90% to 100%, 90% to 98%, or 90% to 95%) of the warp cords within the tire ply steel fabric have a majority of their outer surface contacting a plurality of weft cords. In certain such embodiments, the majority of the outer surface comprises at least 55%, at least 60%, at least 65%, more than 50 up to 80%, more than 50 up to 75%, more than 50 up to 70%, at least 60% up to 80%, at least 60% up to 75%, at least 60% to 70% contacting a plurality of weft cords. In certain embodiments, at least 60%, at least 70%, at least 80%, at least 90%, at least 95%, at least 98%, at least 99% or 100% (e.g., 60% to 100%, 60% to 99%, 60% to 98%, 60% to 95%, 60% to 90%, 60% to 80%, 60% to 70%, 70% to 100%, 70% to 99%, 70% to 98%, 70% to 95%, 70% to 90%, 70% to 80%, 80% to 100%, 80% to 99%, 80% to 95%, 80% to 90%, 90% to 100%, 90% to 98%, or 90% to 95%) of the warp cords within the tire ply steel fabric have at least 55%, at least 60%, at least 65%, more than 50 up to 80%, more than 50 up to 75%, more than 50 up to 70%, at least 60% up to 80%, at least 60% up to 75%, at least 60% to 70% of their outer surface contacting a plurality of weft cords. The percentage of warp cords having at least a majority of their outer surface contacting a plurality of weft cords as well as the particular % outer surface in contact can be determined by various methods, including but not limited to the use of a Scanning Electron Microscope (SEM). It is intended that the foregoing ranges (i.e., percentage of warp cords and percentage of outer surface of the warp cords contacting a plurality of weft cords) can be measured either as an average (i.e., based upon multiple measurement points within a roll of tire ply steel fabric) or upon a single measurement of a sample of tire ply steel fabric measuring 2.5 cm².

In certain embodiments, the tire ply steel fabric has a uniformity such that no more than one additional cord per inch and no less than one missing cord per inch occurs as compared to the ends per inch specification of the fabric (the ends per inch specification varying and including at least those ranges discussed above). Such a uniformity can be described as a uniformity of no more than plus one and no less than minus one. As a non-limiting example, if the specification of the fabric is to have 35 ends per inch of warp cords, such a uniformity requirement would mean that no more than 36 ends per inch are present and no less than 34 ends per inch are present. Uniformity can be measured using various procedures, including but not limited to those involving the use of X-Ray or ultrasound processes such as those described in U.S. Pat. No. 4,706,267. The uniformity measurement can be made upon a slice of the tire ply steel fabric (e.g., 1 meter in length) or upon a sample of the fabric (e.g., 0.4 m²).

In certain embodiments, the tire ply steel fabric directly contacts the rubber covering without any intervening dip coating. In other words, the tire ply steel fabric is not dipped in any type of adhesive coating prior to being covered with rubber.

Without being bound by theory, it is believed that the core-sheath construction of the weft cord in combination with the use of different materials for the core and sheath with the core having more elasticity than the sheath as described herein will produce certain benefits in the resulting tire ply steel fabric as well as in the rubber covered tire ply and in any tire incorporating the rubber covered tire ply. For example, as compared to a weft cord comprised entirely of a relatively inelastic material (e.g., cotton), the weft cords described herein will have a higher Eb, translating into increased stretchiness. Additionally, by utilizing a suitable sheath material (e.g., cotton or one of the other materials described above) in the weft cord, the friction between the weft cords and the warp cords can is increased (especially as compared to a weft cord made entirely of a material such as nylon) resulting in less slippage or movement of the weft cords and a relatively more uniform tire ply steel fabric both during manufacturing and upon incorporation into a tire in its rubber covered form (which can result in a beneficial improvement in tire uniformity).

### Rubber Covering

As discussed above, according to the second embodiment disclosed herein, a rubber covered tire ply is disclosed. The rubber covered tire ply comprises the tire ply steel fabric (as described above) with rubber covering on both the top and bottom surfaces of the fabric. For ease of discussion, the rubber covered tire ply of the second, third, and fourth embodiments is discussed together herein and the following discussion should be considered to apply equally to each embodiment unless specified to the contrary.

As described above, the rubber covered tire ply fabric has its outer surface (i.e., top and bottom) almost entirely or entirely enveloped in rubber (i.e., a rubber composition). By almost entirely or entirely enveloped is meant that both outer surfaces of the fabric are at least 95% covered with the rubber composition, preferably a continuous length of at least 16 cm of the rubber covered fabric (or a section of fabric of at least 40 cm²) meets the foregoing. Accordingly, in certain embodiments, at least 95% of the outer surfaces (top and bottom surfaces) are covered with rubber, including at least 96%, at least 97%, at least 98%, at least 98.5%, at least 99%, at least 99.5%, at least 99.8%, at least 99.9% and even 100%.

The particular composition of the rubber used to prepare the rubber covered tire ply may vary and generally natural rubber, synthetic rubber(s), or a combination thereof may be utilized. Preferred synthetic rubbers include those based upon at least one conjugated diene monomer optionally in combination with a vinyl aromatic monomer. In certain embodiments, the rubber comprises at least one of natural rubber, polyisoprene, styrene-butadiene copolymer, or polybutadiene. Preferred polybutadiene rubbers are those having a cis-1,4-bond content of at least 96%. Exemplary conjugated diener include 1,3-butadiene, 2-methyl-1,3-butadiene-(isoprene), 2,3-dimethyl-1,2-butadiene, 1,3-pentadiene, 1,3-hexadiene and the like as well as mixtures of the foregoing, with 1,3-butadiene being preferred. Exemplary vinyl aromatic monomers include styrene, alpha-methyl styrene, vinyl naphthalene, vinyl pyridine and the like as well as mixtures of the foregoing with styrene being preferred. It should be understood that practice of the present invention is not limited to any particular rubber included hereinabove.

In certain embodiments, the rubber further comprises one or more fillers. Exemplary fillers include reinforcing fillers such as carbon blacks, talcs, silica and other finely divided mineral materials. Carbon black and silica are particularly preferred. Silica and other filler materials excluding carbon black are optionally compounded with the rubber(s) in amounts ranging from 0 to about 80 parts by weight, per 100 parts of rubber (phr). In those embodiments where carbon black is utilized, suitable amounts include about 5 to about 100 parts by weight, per 100 parts of rubber (phr), with about 5 to about 80 phr being preferred and from about 40 to about 70 phr being more preferred. The carbon blacks may include any of the commonly available, commercially-produced carbon blacks but those having a surface area (EMSA) of at least 20 m²/g, preferably at least 35 m²/g up to 200 m²/g, or 35 m²/g up to 100 m²/g are preferred (with surface area values used in this application being determined by ASTM test D-1765 using the cetyltrimethyl-ammonium bromide (CTAB) technique).

In certain embodiments, the rubber further comprises one or more adhesion promoting compounds which facilitate the bonds of the underlying steel cords to the overlying rubber composition. In certain such embodiments, the adhesion promoting compound is a metal complex, preferably a metal (e.g., cobalt, zinc, potassium, aluminum, titanium, zirconium, or molybdenum) salt of an organic acid (e.g., neodecanoic acid, stearic acid, naphthenic acid, rosin, tall oil acid, oleic acid, linoleic acid, linolenic acid and the like). In certain embodiments, the adhesion promoting compound comprises a cobalt salt of an organic acid (e.g., cobalt neodecanoate). In certain embodiments, instead of the rubber including one or more of adhesion promoting compounds, the steel cords are coated or otherwise treated with one or more such compounds (such as those discussed above) prior to being covered with rubber. In certain embodiments, both the steel cords and the overlying rubber composition contain one or more of adhesion promoting compounds, such as those discussed above.

The rubber for covering the tire ply steel fabric is generally cured by sulfur and thus, a sulfur curing agent, such as sulfur or a sulfur donor may be added. Generally, 0.1 to 10 phr, including from 1 to 7.5 phr, including from 1 to 5 phr, and preferably from 1 to 3.5 phr of sulfur, or an equivalent amount of sulfur donor, is added to the rubber composition. One or more cure accelerators may also be utilized in a total amount of 0.1 to 10 phr, preferably 0.5 to 5 ph. The rubber composition may also include from 1 to 3 phr of an antioxidant. Optionally, the rubber composition further comprises 0.1 to 10 phr, preferably 0.5 to 5 phr, of a compound selected from the group consisting of aminosilanes and mercaptosilanes. An adhesion promotor can optionally be added to the rubber composition in order to improve adhesion between the rubber and the steel warp cords. Suitable adhesion promotors are well known and include, but are not limited to, cobalt-containing compounds, resorcinol compounds, and hydrocarbon resins in an amount of 1 to 10 phr or 1 to 5 phr.

As discussed in more detail below, in certain embodiments the rubber composition is formed into sheets that are then used to cover the top and bottom surface of the tire ply steel fabric. The thickness of the rubber sheets may vary depending upon factors including the diameter of the warp cords used in the tire ply steel fabric with relatively larger warp cords generally requiring relatively thicker rubber sheets. In certain embodiments of the fourth embodiment, the rubber sheets used to cover the top and bottom surface of the tire ply steel fabric have a thickness of at least 0.5 mm. In certain embodiments, the rubber sheets used to cover the top and bottom surface of the tire ply steel fabric have a thickness of 0.5 mm to 15 mm (e.g., 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5, mm, 6 mm, 7 mm, 8 mm, 9 mm, 10 mm, 11 mm, 12 mm, 13 mm, 14 mm, 15 mm), preferably 0.5 to 3 mm. In certain embodiments, the overall thickness of the rubber covered tire ply is at least 1 mm, including 1 mm to 5 mm, 1 mm to 4 mm, 1 mm to 3.5 mm, 1 mm to 3 mm, 1 mm to 2.5 mm, 1 mm to 2 mm, 1.5 mm to 5 mm, 1.5 m to 4 mm, 1.5 mm to 3.5 mm, 1.5 mm to 3 mm, 1.5 mm to 2.5 mm, 1.5 mm to 2 mm, 2 mm to 5 mm, 2 mm to 4 mm, 2 mm to 3.5 mm, or 2 mm to 3 mm.

### Tires

As discussed above, the third embodiment disclosed herein is a tire comprising the rubber covered tire ply as described above. The rubber covered tire ply may be utilized in various radially inner areas of a tire. In certain embodiments, the tire comprises a body ply comprised of (consisting of) one layer of the rubber covered tire ply described herein. In certain embodiments, the tire comprises only one body ply comprised of (consisting of) one layer of the rubber covered tire ply described herein and is free of any additional body ply layers. By radially inner is meant radially inner of the road-contacting tread. Generally, a tire comprises a pair of annular beads and the body ply is wrapped circumferentially around the tire and extends from bead to bead, in certain embodiments extending around the beads. In certain embodiments, the tire comprises an inner liner and the body ply is positioned radially outward of the inner liner; in certain such embodiments the body ply is adjacent to the inner liner with no intervening layer(s) between and in other such embodiments the body ply is separated from the inner liner by one or more intervening layers. In certain instances the body ply can be described as a carcass ply. A carcass ply is positioned radially inward in the tire and also comprises a layer comprising rubber-covered cords, generally textile cords; in certain tires one or more carcass plies are utilized and are positioned such that they extend from bead to bead in the tire with their respective cords positioned radially or diagonally (i.e., not circumferentially). When more than one carcass ply is utilized, each may be positioned such that their cord direction differs (e.g., biased to each other).

### Processes for Producing a Tire Ply Steel Fabric

As discussed above, the fourth embodiment disclosed herein is directed to a process for producing a tire ply steel fabric, as described above. The process of the fourth embodiment includes weaving a fabric using the steel cords as warp cords and the non-metallic cords as weft cords to produce a tire ply steel fabric having a top and bottom surface.

Various weaving processes can be utilized to produce the tire ply steel fabric. In certain embodiments of the fourth embodiment, the weaving comprises the use of a loom. The particular configuration of the loom as well as its components, and the weaving process may vary. In certain embodiments of the fourth embodiment, one or more of the following are met: (1) the loom comprises a plurality of rolls containing the warp cords (these rolls may be mounted onto a creel or beam roll), (2) the warp cords pass from the creel through a guide (which may include an eye board and/or guide bars) which positions them parallel to each other, (3) after passing through the guide the warp cords pass through another guide (reed guide) where the weft cords are inserted, (4) after addition of the weft cords, the fabric passes onto a guide roll or rolls, (5) after the guide roll or rolls the fabric is wound onto a roll for storage or shipment, (6) during the weaving process on the loom tension is maintained upon the cords and the fabric by use of multiple feed and/or guide rolls which can assist in maintaining alignment of the tire cords.

### Processes For Producing A Rubber Covered Tire Ply

As discussed above, in certain aspects of the fourth embodiment, the process further comprises adding a covering of rubber on the top and bottom surface of the tire ply steel fabric, thereby producing a rubber covered tire ply comprising the tire ply steel fabric as described above. Such processes comprise providing a tire ply steel fabric (as described above) which has a top and bottom surface and covering each of the top and bottom surface of the tire ply steel fabric with rubber, thereby producing a rubber covered tire ply. As discussed above, the particular composition of the rubber used for the covering may vary and certain details are provided above.

The particular process used to cover the tire ply steel fabric with rubber may vary. In certain embodiments of the fourth embodiment, the covering (i.e., covering of the top and bottom surface of the tire ply steel fabric with rubber) comprises calendaring with sheets of rubber; in certain such embodiments two sheets of rubber are utilized with one sheet applied to the top surface and the second sheet applied to the bottom surface. In certain such embodiments, the calendaring is performed using a creel calendar. In other embodiments of the fourth embodiment, the covering (i.e., covering of the top and bottom surface of the tire ply steel fabric with rubber) comprises extruding of the tire ply steel fabric with the rubber.

The thickness of the rubber sheet(s) used to cover the tire ply steel fabric may vary. In certain embodiments of the fourth embodiment, the rubber sheet(s) used to cover the tire ply steel fabric has/have a thickness as discussed above.

Traditionally, after tire ply fabric has been covered with rubber (e.g., by calendaring), at least a majority or even all of the weft cords are intentionally broken. Breakage of the weft cords allows for uniform expansion and flexing of the rubber covered tire ply during the tire building process and can be especially important when the weft cords are made from a relatively inextensible material (e.g., cotton) which is not sufficiently stretchy to otherwise allow the expansion and flexing of the ply that is necessary during tire building. Utilization of the non-metallic core-sheath construction weft cords as described herein allows for elimination of the step of breaking the weft cords. Accordingly, in certain embodiments of the second, third and fourth embodiments, the rubber covered tire ply fabric has at least 95% of its weft cords unbroken. In other embodiments, at least 90% to 100% (e.g., 90%, 91%, 92%, 93%, 94%, 95%, 96%, 97%, 98%, 99%, 99.5% or 100%), including at least 90% to 99.5%, at least 90% to 99%, at least 90% to 98%, at least 90% to 95%, at least 92% to 100%, at least 92% to 99.5%, at least 92% to 99%, at least 92% to 98%, at least 95% to 100%, at least 95% to 99.5%, at least 95% to 99%, at least 95 to 98%, at least 96% to 100%, at least 96% to 99.5%, at least 96% to 99%, at least 96% to 98%, at least 97% to 100%, at least 97% to 99.5%, or at least 97% to 99% of the weft cords of the rubber covered tire ply fabric of the second, third and fourth embodiments is unbroken.

This application discloses several numerical range limitations that support any range within the disclosed numerical ranges, even though a precise range limitation is not stated verbatim in the specification, because the embodiments of the compositions and methods disclosed herein could be practiced throughout the disclosed numerical ranges. With respect to the use of substantially any plural or singular terms herein, those having skill in the art can translate from the plural to the singular or from the singular to the plural as is appropriate to the context or application. The various singular or plural permutations may be expressly set forth herein for sake of clarity.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references, including but not limited to patents, patent applications, and non-patent literature are hereby incorporated by reference herein in their entirety.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

What is claimed is:

1-21. (canceled)

22. A tire ply steel fabric comprising:
a. a plurality of steel warp cords having a diameter of at least 0.3 mm,
b. a plurality of weft cords each weft cord having a core-sheath construction wherein the core comprises at least one filament of a non-metallic material having an Eb of at least 100% and the sheath comprises a different non-metallic material having an Eb of less than 100%, and
c. a top and a bottom surface.

23. The tire ply steel fabric of claim 22, wherein the fabric has a spacing of the steel warp cords of at least 30 ends per inch.

24. The tire ply steel fabric of claim 22, wherein the fabric has an open area of at least 10% (based upon a 2.5 cm² fabric area).

25. The tire ply steel fabric of claim 22, wherein the steel warp cords have a diameter of no more than 2 mm.

26. The tire ply steel fabric of claim 22, wherein at least one of the following is met:
a. the core of the weft cords comprises at least one material selected from nylon, polyester, polypropylene, polyethylene, aramaid, or spandex;
b. the sheath of the weft cords comprises at least one material selected from cotton, rayon, wool, sisal, cellulose, silk, linen, or flax; or
c. the sheath of the weft cords comprises carded, chopped fibers of nylon/polyamide, polyester, polypropylene, wool, polyvinyl fibers, acrylic, polyethylene, polyurethane, or a combination thereof.

27. The tire ply steel fabric of claim 22, wherein each warp cord comprises more than one filament and has a 1×N construction wherein N comprises an integer from 2-10.

28. The tire ply steel fabric of claim 22, wherein at least one of the following is met:
a. at least a majority (by number) of the warp cords have at least a majority of their outer surface contacting a plurality of weft cords;
b. the core filament(s) of the weft cords have at least 75% of its outer surface surrounded by the non-metallic sheath; or
c. the fabric comprises 1 to 10 wefts per inch.

29. A rubber covered tire ply comprising the tire ply steel fabric of claim 22 with rubber covering on both the top and bottom surfaces of the fabric.

30. The rubber covered tire ply of claim 29, wherein at least 95% of the weft cords are unbroken.

31. The rubber covered tire ply of claim 30, wherein at least one of the following are met:
a. the warp cords have a uniformity of no more than plus one and no less than minus one; or
b. the tire ply steel fabric directly contacts the rubber without any intervening dip coating;
c. the rubber covering has a thickness of 0.5 to 3 mm.

32. A tire comprising the rubber covered tire ply of claim 30.

33. The tire of claim 30 having a body ply comprised of one layer of the rubber covered tire ply.

34. A process for producing a tire ply steel fabric comprising
providing a plurality of steel cords having a diameter of at least 0.3 mm and a plurality of a non-metallic cords having a core-sheath construction wherein the core comprises at least one filament of a non-metallic material having an Eb of at least 100% and the sheath comprises a different non-metallic material having an Eb of less than 100%,
weaving a fabric using the steel cords as warp cords and the non-metallic cords as weft cords to produce a tire ply steel fabric having a top and a bottom surface.

35. The process of claim 34, wherein at least one of the following is met:
a. the weaving is performed using a loom;
b. the tire ply steel fabric has at least 30 ends per inch;
c. the fabric has an open area of at least 10% (based upon a 2.5 cm² fabric area);
d. the steel warp cords have a diameter of no more than 2 mm.

36. The process of claim 35, wherein at least one of the following is met:
a. the core of the weft cords comprises at least one material selected from nylon, polyester, polypropylene, polyethylene, aramaid, or spandex;
b. the sheath of the weft cords comprises at least one material selected from cotton, rayon, wool, sisal, cellulose, silk, linen, or flax; or
c. the sheath of the weft cords comprises carded, chopped fibers of nylon/polyamide, polyester, polypropylene, wool, polyvinyl fibers, acrylic, polyethylene, polyurethane, or a combination thereof.

37. The process of claim 34, wherein at least one of the following is met:
a. within the tire ply steel fabric at least a majority (by number) of the warp cords have at least a majority of their outer surface contacting a plurality of weft cords;
b. within the tire ply steel fabric the core filament(s) of the weft cords have at least 75% of its outer surface surrounded by the non-metallic sheath; or
c. the tire ply steel fabric comprises 1 to 10 wefts per inch.

38. A tire ply steel fabric produced according to the process of claim 34.

39. The process of claim 34, further comprising covering both the top and the bottom surfaces of the fabric with rubber.

40. A rubber covered tire ply comprising the tire ply steel fabric of claim 38 with rubber having a thickness of 0.5 to 3 mm covering on both the top and bottom surfaces of the fabric.

41. The rubber covered tire ply of claim 40, wherein at least one of the following is met:
a. 95% of the weft cords are unbroken; or
b. the tire ply steel fabric directly contacts the rubber without any intervening dip coating.

42. A tire ply steel fabric comprising:
a. a plurality of steel warp cords having a diameter of 0.3-2 mm;
b. a plurality of weft cords each weft cord having a core-sheath construction wherein the core comprises at least one filament of a non-metallic material having an Eb of at least 100% and selected from the group consisting of nylon, polyester, polypropylene, polyethylene, aramaid, spandex, and combinations thereof, and the sheath comprises a different non-metallic material having an Eb of less than 100% and selected from the group consisting of cotton, rayon, wool, sisal, cellulose, silk, linen, flax, and combinations thereof; and
c. a top and a bottom surface,
wherein the fabric has a spacing of the steel warp cords of at least 30 ends per inch.
